(19) United States
(12) Patent Application Publication
(10) Pub. No.: US 2025/0271166 A1
(43) Pub. Date: Aug. 28, 2025

(54) Ultra High Efficiency Energy Balancing and Recovery System

(71) Applicant: Budderfly, Inc., Shelton, CT (US)

(72) Inventors: Vishal Patwari, Hamden, CT (US); Matthew Nemerson, New Haven, CT (US); Albert Subbloie, Orange, CT (US)

(73) Assignee: Budderfly, Inc., Shelton, CT (US)

(21) Appl. No.: 18/584,403

(22) Filed: Feb. 22, 2024

(51) Int. Cl. F24F 11/79; F24F 11/46

(52) U.S. Cl. CPC F24F 11/79; F24F 11/46

(57) ABSTRACT

A system and method for improving the efficiency of HVAC ventilation optimizing air quality while maintaining energy efficiency. The system uses a controller which coordinates operation of room by room heating/cooling delivery devices and a heat exchanger based ventilator in order to maintain air quality and a comfortable temperature.

### FIELD OF THE INVENTION

The present disclosure relates generally to systems and methods for HVAC (Heating Venting and Air-Conditioning) airflow optimization and efficiency. More specifically, the balance between fresh breathable air for occupants while not replacing air too quickly when it is not needed so as not to require additional energy to condition this air. Maintaining a balance between airflow using sensors and variable speed fans and ducts is presented to optimize energy use while maintaining an optimal CO2 level for fresh breathable air and for keeping the room in pressure balance. A special emphasis is made for the optimization of peak energy use periods and the reduction of demand expenses.

### BACKGROUND OF THE INVENTION

HVAC equipment is one of the largest energy users in commercial establishments that serve the public. Gains in efficiency leading to energy savings, even when small in terms of percentage, can lead to significant monetary savings. Improved efficiency can also improve the lifespan of the equipment.

In typical HVAC systems, heat is absorbed by the evaporator coil. Warm air, drawn in through a vent, blows over a cold evaporator coil raising the refrigerant temperature. This heat is transferred outside, and the refrigerant gets cold. This process is repeated.

Many of these HVAC systems are installed on rooftops and they will heat or cool the outside air and then pump that conditioned air into the room spaces. While the conditioned air is introduced, necessarily room air must exit to maintain a pressure balance. As a result, room setpoint temperature air or air close to that temperature is expelled from the building. Furthermore, rooftop units suffer a disadvantage of inconsistent control in that certain spaces may be too warm or too cold whereas other spaces such as kitchens may naturally be hot and may require different heating/cooling parameters to keep the space comfortable.

The intake of air from the outside and/or the transfer of air from the inside to the outside makes the HVAC system work that much harder as, on warm days, the pre-cooled air from inside the premises is pulled through the vents and exhausted to the outside. To keep the room in balance, MUA (make up air) units bring air in from the outside to maintain a slightly positive balance. This in turn leads to warm (or cold) air entering the premises requiring conditioning. When too much air is pulled out and a negative pressure balance exists, doors may be pulled open on their own. When a positive pressure balance exists doors may prove hard to open.

More than just balance however, there is also the CO2 content which builds up with the occupancy in the building. In order to maintain a good airflow with good breathable air, CO2 content can be measured, and ventilation speeds can be adjusted to provide for more or less air as needed. For example, when a given room has no occupants, CO2 buildup is slower. In this regard, there may be no need to bring in air from the outside and have to pay to have this conditioned.

On the other hand, when a room is full of people, the heat from the people will require more cooling and the CO2 in the air should be monitored and more fresh air brought in to maintain a good oxygen level for breathing fresh air. Bringing in too much air will force conditioning the air and cost more in energy cost with little benefit. Too little will result in stale air with potential health implications. Having the right balance is essential for optimizing energy use and comfort.

It is also likely that when the room is full of people, kitchen vents are pulling out more air due to cooking exhaust, and ovens are on, the establishment is quite likely to be at a time when peak energy use is being consumed.

Korean patent Ventilation System Of Demand Control KR100556066B1 describes a way of monitoring CO2 as a measure of biological pollution and presents a demand response system for ventilation. This system does not integrate with cooling/heating needs.

US patent US11079127B2, titled Systems and methods for air ventilation filed by Tran uses a baffle controlled by an actuator to adjust airflow based on air quality but Tran fails to integrate with a heating/cooling system.

US patent US20050279845A1 teaches ways of controlling make-up and transfer air in an occupied space, however this system uses heaters/coolers in line between the incoming makeup air and the room through use of a rooftop unit with multiple fans.

Thus, it would be highly beneficial to have a system that utilize both variable refrigerant flow systems and an air recycling system that maintains good air quality without sacrificing or wasting significant amounts energy by expelling conditioned air.

### SUMMARY OF THE INVENTION

What is desired then is a system and method that can optimize energy use while at the same time ensuring that the air remains fresh in the facility and a good pressure balance is achieved.

It is further desired to provide a system and method that can utilize a combination of ERV (energy recovery ventilators), VRF (variable refrigerant flow) heat pumps, and counterflow duct systems to provide optimum temperature balance while providing fresh air circulation in a facility, and in particular in a restaurant environment.

It is further desired to provide a system and method that can provide such optimization in a way that can reduce demand charges by adjusting usage during peak demands to optimize energy costs.

Is it still further desired to provide a system and method that can use historic energy usage measurements, current billing models from the utility of record, and environmental condition data to adjust automatically to changing variables that can influence energy consumption.

Is it still further desired to provide a system and method that can utilize machine learning to estimate when levels of CO2 or pressure in rooms will build up based on variables such as occupancy and activity within the facility and use that information to control the HVAC system.

The system monitors outside temperature and occupancy levels to determine ideal use and most appropriate use when occupancy is highest and temperature outside is highest. The system can also leverage external feeds such as temperature forecasts to make predictions. For example, if CO2 levels are low, but there are no occupants, the urgency to maintain fresh air with optimal C02 levels is less important. Of course, there are staff working at the facility but the amount of CO2 going into the environment with minimal occupancy is measurable and the machine learning aspect of the system detects, measures and estimates this.

Similarly, there are external factors such as kitchen vents, drive through windows, doors that open and close that allow air to enter and adjust the balance of pressure in the facility. Again, the machine learning aspects of the system detect, monitor and learn from the sensors installed at the facility to properly estimate and plan peak usage period management accordingly.

In certain aspects, A HVAC system for a building is provided with a heat exchanger which comprises a fan and a heating/cooling system with a heat/cooling source remote to a heat/cooling delivery device, a heat transfer fluid transferred between the heat/cooling source and the heat/cooling delivery device to enable the heat/cooling delivery device to deliver heat/cooling. A first duct is connected to the heat exchanger such that the first duct is in fluid communication with a first exchanger space of the heat exchanger and the first duct is in fluid communication with a room space in order to introduce fluid into the room space. A second duct is connected to the heat exchanger such that the second duct is in fluid communication with a second exchanger space of the heat exchanger and the second duct in fluid communication with the first room space in order to receive fluid from the room space. The heat exchanger transfers heat between fluid passing through the second heat exchanger space to fluid passing through the first heat exchanger space such that external fluid to the building which is the fluid passing through the first heat exchanger space is brought closer in temperature to the fluid from the room space. The heat/cooling delivery device is located in the room space and receives the heat transfer fluid to warm and/or cool the room space.

In certain aspects a controller is in communication with the heat exchanger and the heating/cooling system. The controller coordinates operation of the heat exchanger and the heating/cooling system based on sensor data received from one or more sensors in the room space. In certain aspects, between the heat exchanger and the room space along the first duct an energy consuming heat/cooling device is absent such that pre-heating and pre-cooling between the heat exchanger and the room space is substantially not provided for the fluid exiting the heat exchanger and entering the room space via the first duct.

In certain aspects the room space comprises a plurality of room spaces, the heat/cooling delivery device includes a plurality of heat/cooling delivery devices, the first duct includes a plurality of first ducts and the second duct includes a plurality of second ducts each one of the plurality of room spaces including one of the plurality of heat/cooling delivery devices and each one of the plurality of room spaces connected to one of the first ducts and to one of the second ducts. In further aspects the controller coordinates operation of each of the plurality of heat/cooling delivery devices and circulation of fluid via the one of the first ducts and the one of the second ducts corresponding with the room space associated with each of the heat/cooling delivery devices. In still further aspects one or more of the plurality of first and/or second ducts includes a blocking device configured to fully or partially close its associated duct, wherein the controller controls operation of the blocking device. In still other aspects each heat/cooling delivery device is associated with a thermostat and at least two of the heat/cooling delivery devices are associated with different temperature setpoints. In still further aspects the heating/cooling system is a geothermal device.

In further aspects the heating/cooling system includes a plurality of refrigerant line sets, each refrigerant line set supplies refrigerant to at least one refrigerant line that supplies refrigerant to one of the plurality of heat/cooling delivery devices. In yet other aspects the system is configured such that when one of the plurality of room spaces requires cooling and another one of the plurality of room spaces requires heating the system directs heat transfer fluid that has already passed through the heat/cooling delivery device of the room space that requires cooling to the heat/cooling delivery device of the another one of the plurality of room spaces that requires heating. In still further aspects a supplemental heating system is controlled by the controller and provided in one or more of the room spaces. In certain aspects the supplemental heating system is activated based on an external temperature being below a threshold or a rate change of temperature in one or more of the room spaces is below a second threshold.

In still other aspects an air quality sensor is positioned in the room space and is connected to the controller wherein the fan of the heat exchanger is activated by the controller based on the air quality sensor indicating air quality below a threshold. In further aspects the heat exchanger is activated by the controller, the controller activates the heating/cooling system based on a set point for the room space as compared to a measured temperature of the room space. In still other aspects a temperature of air exiting the heat exchanger into the first duct is substantially the same as a temperature of that air exiting the first duct into the first room space.

Still other objects are achieved by providing a method of controlling an HVAC system for a building including implementing a control program which control program is software executing on a computer, the control program coordinating operation of a heat exchanger and a heating cooling system between a plurality of room spaces based on sensor data associated with one or more of the plurality of room spaces. In preferred aspects the heat exchanger comprises a fan and the heating/cooling system includes a heat/cooling source remote to a plurality of heat/cooling delivery devices, a heat transfer fluid transferred between the heat/cooling source and the heat/cooling delivery device to enable the heat/cooling delivery device to deliver heat/cooling. The building includes a plurality of first ducts, each connected to the heat exchanger such that each first duct is in fluid communication with a first exchanger space of the heat exchanger and each first duct is in fluid communication with a corresponding one of a plurality of a room spaces in the building in order to introduce fluid into the corresponding room space. The building further includes a plurality of second ducts connected to the heat exchanger such that the second ducts are in fluid communication with a second exchanger space of the heat exchanger and each of the second ducts in fluid communication with a corresponding one of the first room spaces in order to receive fluid from that corresponding room space. The heat exchanger transfers heat between fluid passing through the second heat exchanger space to fluid passing through the first heat exchanger space such that external fluid to the building which is the fluid passing through the first heat exchanger space is brought closer in temperature to the fluid from the building. Each heat/cooling delivery device is located in one of the room spaces and receives the heat transfer fluid to warm and/or cool the room space.

In certain aspects the sensor data comprises one or more of temperature, pressure, air quality, humidity, occupancy and light. In further aspects, the sensor data comprises temperature and air quality. In further aspects, the air quality sensor comprises a CO2 sensor. In still further aspects, a temperature of air exiting the heat exchanger into the first ducts is substantially the same as a temperature of that air exiting the first ducts into the first room space. In yet further aspects, the building is provided with energy using heat/cooling devices are absent along one or more of the first ducts. In yet further aspects, the control program controls the building to transfer heating energy in one of the plurality of rooms to another of the plurality of rooms based on temperature sensor data. In still other aspects the controller activates the fan of the heat exchanger based on CO2 sensor data indicating that CO2 concentration exceeds a threshold.

Other aspects and features of the present invention will become apparent from consideration of the following description taken in conjunction with the accompanying drawings.

### BRIEF DESCRIPTION OF THE DRAWINGS

FIG. 1 is a functional diagram of an implementation of the present system.

FIG. 2 shows details concerning a component of the system of FIG. 1

FIG. 3 is a functional flow diagram of the system of FIG. 1.

FIG. 4 is a functional flow diagram showing the control system.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

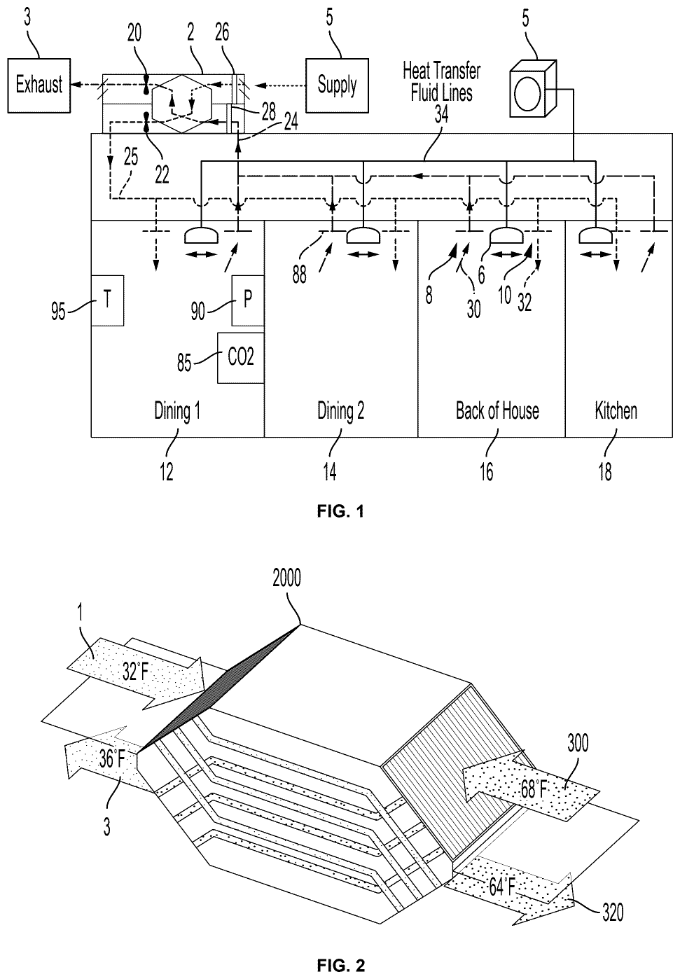

Turning to the drawings, FIG. 1 the system architecture is shown in an example of a restaurant with dining rooms 12/14, back of house 16 and kitchen 18. Each of these may be considered room spaces which require different control parameters and different heating/cooling and ventilation needs. The room spaces do not necessarily need to be completely physically separated by four walls and closed doors as some of the spaces may be continuous or semi-continuous in that no door requires opening to move between the spaces, but they are still separated in some manner due to e.g. a hallway, narrowed spaces or other features/size considerations that may result in different heat/cooling device placement and vent placement and/or multiple sensors of the same type throughout the space.

The building is shown with a rooftop heat exchanger system (e.g. ERV) which has fans 20/22 that draw in and exhaust air. Although shown on the rooftop, the heat exchanger system 2 is preferably external to the building or is installed with venting to the exterior of the building in order to exhaust air and obtain fresh supply air. Filters 26/24 are provided as well to ensure clean incoming air and to inhibit clogging the heat exchanger with dust/particles from the various room spaces. As one example, a counterflow heat exchanger 2000 (FIG. 2) may be provided in the heat exchanger system 2. The supply air 1 from outside enters the heat exchanger 2000 and the exhaust air 3 exits at a temperature relatively close to supply temperature. For example, a difference of less than 10 Deg F, preferably less than 6 Deg F, more preferably less than 5 Deg F. These relatively low temperature differences between supply 1 and exhaust 3 air are a result of the heat exchanger 2000 transferring energy from the room exhaust 300 air to the incoming supply air 1 so that fresh air 320 delivered into the room is relatively close in temperature to that air exiting the room. Here, there is also relatively low temperature difference, for example, a difference of less than 10 Deg F, preferably less than 6 Deg F, more preferably less than 5 Deg F. Similar to the exhaust/supply air difference, this low difference of the fresh/exhaust air results in the ventilation system reduces energy losses to the conditioned air due to use of ventilation. In comparison, large rooftop HVAC units often push in conditioned air (hot or cold) and room temperature air naturally is exhausted outside. On a cold day, this could result in 70 degree air being exhausted into the 30 degree outside environment. This large temperature difference is equated to wasted (and expensive) energy losses.

Given the reduced need for heating or cooling due to reduced losses, a smaller and more efficient heat/cooling system can be employed. Specifically, a VRF system, heat pump or other heating/cooling device that enables delivery on a room space by room space basis can be utilized. The VRF system shown uses a compressor/heat pump 5 external to the building and heat transfer fluid lines 34 to deliver energy to the in room heat/cooling delivery devices 6. In the case of a VRF (sometimes called a mini split), the cassette 6 can call for heating/cooling as needed without requiring heat/cooling to be delivered to each room.

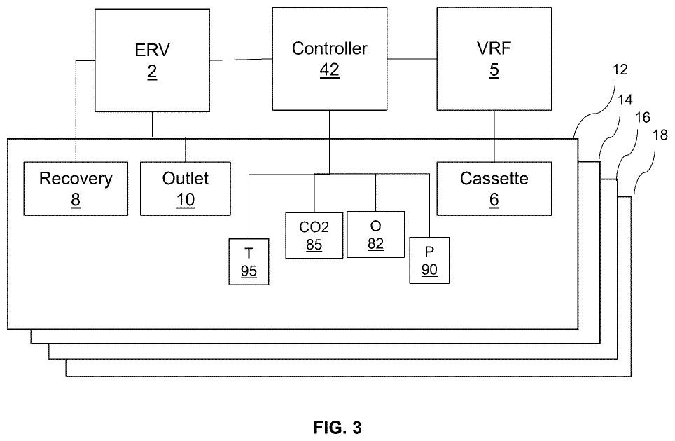

As shown in FIGS. 1 and 3, the rooms may include a thermostat 95, pressure sensor 90 and CO2/air quality 85 sensors. These sensors 85/90/95 are in communication with a controller 42. This controller coordinates operation of the ventilation/heat exchanger system 2 and the heat/cooling system 5 to balance the needs of temperature and room air quality/comfort. For example, based on pressure and/or CO2 readings, the ERV can be activated to replace stale air with fresh air. The pressure can be used to adjust the recovery 8 and outlet 10 vents to e.g. allow more or less air delivery in order to balance the pressure of the room. These vents may have blocking devices 88 which are moveable by the controller 42 to adjust the opening size/how freely air flows therethrough. If CO2 readings are above a set threshold, the ERV could be activated and in this scenario, it would be expected that this ventilation exchange will ultimately cause a temperature change to the room as the outlet 10 air is usually a few degrees different from the recovery 8 air. The controller 42 therefore may activate the heat/cooling system to deliver heat/cooling to the applicable room that the ERV is activated in. This can be done before the thermostat 95 calls for heating/cooling as it is known that use of the ERV may result in a temperature change. However, activation of the ERV may not automatically result in need for heating/cooling. For example, heat will be generated in a room occupied by numerous people and CO2 levels will also rise, likely resulting in activation of the heat exchanger/ERV. The occupancy may be determined by, for example, an occupancy sensor 82 or by the change in CO2/room quality or combinations thereof. The thermostat 95 may also include occupancy sensors therein such that a stand alone occupancy sensor 82 is not needed. If heating would normally be required to a small extent given the exterior temperature, the high occupancy can indicate that activation of the heating/cooling system is un-necessary as the body heat can warm the room adequately in comparison to the temperature differential resulting from use of the ERV. The recovery 8 and outlet 10 vents may be of the type that can be opened/closed as well by the controller 42. Thus, if one room requires ventilation, other rooms in the duct system may have their recovery 8 and outlet 10 vents closed to avoid circulating air and the resultant temperature differential that would require energy input. Thus, the controller 42 can control operation of the fans 20/22 of the ERV in addition to the room space by room space vents 8/10 in order to deliver ventilation in the areas needed. Given that each room has its own heat/cooling delivery device and sensors, the controller 42 or the sensors/thermostat can be set differently for each room and different thresholds of acceptable sensor values (temperature, pressure, humidity etc) can be set in the controller and those settings may be different for each room, thus allowing individualized control for each room space.

Further, it is anticipated that there may be scenarios where some room spaces call for heating while other rooms simultaneously call for cooling. In this scenario, the recovery 8 and outlet 10 vents can be manipulated to assist in transferring heat. For example, the kitchen recovery 8 vent may be opened and air drawn from the kitchen, through the heat exchanger 2 and then the outlets 10 in the other room spaces that require heating may be opened to redirect that warmer kitchen air to the cooler spaces. However, the system would monitor the pressure sensor 90 to ensure that pressure differentials do not become too large. In some scenarios this may not be practical if the kitchen is largely sealed off from the rest of the restaurant, however, if the kitchen has an open area that allows for free flow of air, by obtaining warmer air from the back of the kitchen and moving it through the heat exchanger and expelling it into other room spaces that need warming, the cooler air from those rooms would fill in to the kitchen space to balance the pressure, thus the thermostat 95 in one room may call for heating and the ordinary manner of responding to that would be to activate the heating device because the heat exchanger system and the heating/cooling device are not coordinated in control. In the present system, it can be recognized that certain spaces are warmer than others and air can be recirculated through the system in a manner that by virtue of the coordinated control of the systems the VRF/heating/cooling device is not activated even though a normal implementation of a thermostat 95 would have ordinarily called for heating. Thus, by allowing the controller 42 to coordinate operation between the different systems and sensors disclosed herein, efficiencies can be obtained.

Additionally, the heat transfer fluid within the lines 34 may be redirected within the system to aid in the transfer of energy. Given that kitchens have cooing appliances generating substantial heat, the VRF 5 may be delivering cooling to the kitchen. In that scenario, the heat transfer fluid would extract energy from the air in the kitchen via the cassette 6 (in the kitchen) and then the VRF can redirect this now warmed heat transfer fluid to a cassette in a room that may be calling for heat, thus further coordination of the two systems to both transfer heat away from the kitchen and to other rooms can be accomplished due to the coordination by the controller of the systems described herein. The controller 42 may also be connected to external data sources to indicate weather or exterior temperature or there may be exterior sensors 96 (e.g. temperature, wind, sunlight) connected to the controller 42 (separately or as part of the heat exchanger 2 or VRF 5). Although a VRF is shown, a variety of heat/cooling systems can be used, for example geo thermal systems can be used to distribute heat transfer fluid throughout various room spaces and it is further understood that a combination of the VRF/heat pump systems and geo thermal may be employed to obtain further efficiencies. Furthermore, supplemental heating systems 800 may be provided in the event of very cold weather and these may be controlled by the controller 42 as well. For example, baseboard heating, forced hot air or other heating systems know to those of skill in the art. These supplemental heating systems 800 would be activated when the room by room devices 5 are unable to provide enough heat or when doing so is less efficient. This determination by the controller may be based on the outside environment temperature as determined by sensors or a data connation from weather stations or weather reporting.

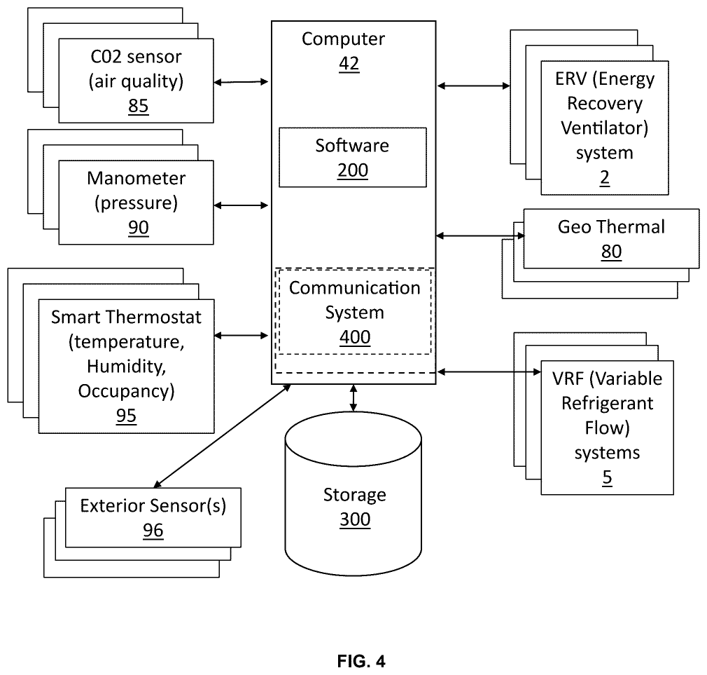

Referring to FIG. 4, the controller may be a computer 42 with central management software 200 executing thereon. The computer may have one or more communications systems such as wifi, Bluetooth, ethernet and other communications systems to obtain sensor data and communicate with the heat exchanger system 2 and the heating/cooling system 5. The software 200 connects to various on site systems including ERV (Energy Recovery Ventilator) systems 2, VRF (Variable Refrigerant Flow) 5, geo thermal 80. It is understood that geo thermal 80 may be one type of VRF system, others may include heat pumps/mini-splits and a combination of geothermal and heat pump/mini-split systems can be used as well. The controller 42 can be configured to control the various features of all these devices, for example the ERV fans may be controllable by the controller 42, as can be the opening/closing of the vents 8/10. Furthermore, the controller 42 can control the heating/cooling delivery device 6 (e.g. cassette) in terms of fan speed, cooling/heating and in some cases dehumidification may be an option as well. Furthermore, delivery and re-direction of the heat transfer fluid by the controller 42 can further add efficiencies to the system and use of geothermal 80 can be controlled by the controller 42 to direct the geothermal system's heat transfer fluid to the appropriate rooms for heating/cooling delivery as needed.

The system is also connected to a number of strategically placed sensors such as CO2 sensors 85 to measure fresh air, manometers 90 to measure pressure and smart thermostats 95 that measure temperature, humidity as well as occupancy (separate humidity, temperature and occupancy sensors may also be used). The system may further be connected to various exterior sensors 96. The storage 300 stores data related to sensor data, patterns, control inputs and results thereof so that the controller software 200 can better determine the appropriate control inputs in a given scenario.

The system will monitor the CO2 content of various room spaces and if there is too much CO2, the controller 42 will exchange air using the heat exchanger system 2.

Similarly the system will monitor the pressure in the various rooms and if there is a need to adjust the pressure, the system will open or close the various inlets/outlets 8/10 to balance the pressure accordingly.

Preferably the heat exchanger system 2 is provided in a way that the temperature of the air 320 exiting the heat exchanger 2000 which is going to the room is relatively close to or equal to the temperature of that air when it enters the room 32. In preferred aspects the temperature differential of such air 320 between the exit of the heat exchanger and when that air 32 enters the room is less than 10 deg F, more preferably less than 5 deg F and even more preferably less than 2 deg F. In preferred embodiments, that temperature difference is substantially non-existent. In this manner, the primary energy using heating/cooling devices are separate from the ducts 25 and while there may be minor temperature changes to that air as it moves through the ducts, generally, the temperature exiting the heat exchanger 2000 and the temperature of the air 32 entering the room is substantially the same.

It will be understood by those of skill in the art that while examples using RTUs are utilized, the same system can be adapted and used for any air cooling or heating system

Although the invention has been described with reference to a particular arrangement of parts, features and the like, these are not intended to exhaust all possible arrangements or features, and indeed many other modifications and variations will be ascertainable to those of skill in the art.

What is claimed:

1. An HVAC system for a building comprising:
a heat exchanger which comprises a fan;
a heating/cooling system with a heat/cooling source remote to a heat/cooling delivery device, a heat transfer fluid transferred between the heat/cooling source and the heat/cooling delivery device to enable the heat/cooling delivery device to deliver heat/cooling;
a first duct connected to the heat exchanger such that the first duct is in fluid communication with a first exchanger space of the heat exchanger and the first duct is in fluid communication with a room space in order to introduce fluid into the room space;
a second duct connected to the heat exchanger such that the second duct is in fluid communication with a second exchanger space of the heat exchanger and the second duct in fluid communication with the first room space in order to receive fluid from the room space;
wherein the heat exchanger transfers heat between fluid passing through the second heat exchanger space to fluid passing through the first heat exchanger space such that external fluid to the building which is the fluid passing through the first heat exchanger space is brought closer in temperature to the fluid from the room space;
the heat/cooling delivery device is located in the room space and receives the heat transfer fluid to warm and/or cool the room space.

2. The system of claim 1 further comprising:
a controller in communication with the heat exchanger and the heating/cooling system wherein the controller coordinates operation of the heat exchanger and the heating/cooling system based on sensor data received from one or more sensors in the room space.

3. The system of claim 1 wherein between the heat exchanger and the room space along the first duct an energy consuming heat/cooling device is absent such that pre-heating and pre-cooling between the heat exchanger and the room space is substantially not provided for the fluid exiting the heat exchanger and entering the room space via the first duct.

4. The system of claim 2 wherein the room space comprises a plurality of room spaces, the heat/cooling delivery device includes a plurality of heat/cooling delivery devices, the first duct includes a plurality of first ducts and the second duct includes a plurality of second ducts each one of the plurality of room spaces including one of the plurality of heat/cooling delivery devices and each one of the plurality of room spaces connected to one of the first ducts and to one of the second ducts.

5. The system of claim 4 wherein the controller coordinates operation of each of the plurality of heat/cooling delivery devices and circulation of fluid via the one of the first ducts and the one of the second ducts corresponding with the room space associated with each of the heat/cooling delivery devices.

6. The system of claim 5 wherein one or more of the plurality of first and/or second ducts includes a blocking device configured to fully or partially close its associated duct, wherein the controller controls operation of the blocking device.

7. The system of claim 4 wherein each heat/cooling delivery device is associated with a thermostat and at least two of the heat/cooling delivery devices are associated with different temperature setpoints.

8. The system of claim 1 wherein the heating/cooling system is a geothermal device.

9. The system of claim 4 wherein the heating/cooling system includes a plurality of refrigerant line sets, each refrigerant line set supplies refrigerant to at least one refrigerant line that supplies refrigerant to one of the plurality of heat/cooling delivery devices.

10. The system of claim 4 wherein the system is configured such that when one of the plurality of room spaces requires cooling and another one of the plurality of room spaces requires heating the system directs heat transfer fluid that has already passed through the heat/cooling delivery device of the room space that requires cooling to the heat/cooling delivery device of the another one of the plurality of room spaces that requires heating.

11. The system of claim 4 further comprising a supplemental heating system controlled by the controller.

12. The system of claim 11 wherein the supplemental heating system is activated based on an external temperature being below a threshold or a rate change of temperature in one or more of the room spaces is below a second threshold.

13. The system of claim 1 further comprising an air quality sensor positioned in the room space and connected to the controller wherein the fan of the heat exchanger is activated by the controller based on the air quality sensor indicating air quality below a threshold.

14. The system of claim 13 wherein when the heat exchanger is activated by the controller, the controller activates the heating/cooling system based on a set point for the room space as compared to a measured temperature of the room space.

15. The system of claim 1 wherein a temperature of air exiting the heat exchanger into the first duct is substantially the same as a temperature of that air exiting the first duct into the first room space.

16. A method of controlling an HVAC system for a building comprising:
implementing a control program which control program is software executing on a computer, the control program coordinating operation of a heat exchanger and a heating cooling system between a plurality of room spaces based on sensor data associated with one or more of the plurality of room spaces;
the heat exchanger comprises a fan;
the heating/cooling system includes a heat/cooling source remote to a plurality of heat/cooling delivery devices, a heat transfer fluid transferred between the heat/cooling source and the heat/cooling delivery device to enable the heat/cooling delivery device to deliver heat/cooling;
the building includes a plurality of first ducts, each connected to the heat exchanger such that each first duct is in fluid communication with a first exchanger space of the heat exchanger and each first duct is in fluid communication with a corresponding one of a plurality of a room spaces in the building in order to introduce fluid into the corresponding room space;
the building includes a plurality of second ducts connected to the heat exchanger such that the second ducts are in fluid communication with a second exchanger space of the heat exchanger and each of the second ducts in fluid communication with a corresponding one of the first room spaces in order to receive fluid from that corresponding room space;
wherein the heat exchanger transfers heat between fluid passing through the second heat exchanger space to fluid passing through the first heat exchanger space such that external fluid to the building which is the fluid passing through the first heat exchanger space is brought closer in temperature to the fluid from the building;
each heat/cooling delivery device is located in one of the room spaces and receives the heat transfer fluid to warm and/or cool the room space.

16. The method of claim 15 wherein the sensor data comprises one or more of temperature, pressure, air quality, humidity, occupancy and light.

17. The method of claim 16 wherein the sensor data comprises temperature and air quality.

18. The method of claim 17 wherein the air quality sensor comprises a CO2 sensor.

19. The method of claim 15 wherein a temperature of air exiting the heat exchanger into the first ducts is substantially the same as a temperature of that air exiting the first ducts into the first room space.

20. The method of claim 15 wherein the building is provided with energy using heat/cooling devices are absent along one or more of the first ducts.

21. The method of claim 15 wherein the control program controls the building to transfer heating energy in one of the plurality of rooms to another of the plurality of rooms based on temperature sensor data.

22. The method of claim 15 wherein the controller activates the fan of the heat exchanger based on CO2 sensor data indicating that CO2 concentration exceeds a threshold.
